(19) United States
(12) Patent Application Publication
(10) Pub. No.: US 2009/0289556 A1
(43) Pub. Date: Nov. 26, 2009

(54) Discharge lamp lighting apparatus for lighting multiple discharge lamps

(75) Inventor: Shinichi Suzuki, Nagano (JP)

Correspondence Address: CARRIER BLACKMAN AND ASSOCIATES, 43440 WEST TEN MILE ROAD, EATON CENTER, NOVI, MI, 48375, US

(73) Assignee: Minebea Co., Ltd, Kitasaku-gun (JP)

(21) Appl. No.: 12/454,585

(22) Filed: May 20, 2009

(30) Foreign Application Priority Data
May 21, 2008 (JP) 2008-132797

(51) Int. Cl. H05B 41/14

(52) U.S. Cl. 315/121

(57) ABSTRACT

A discharge lamp lighting apparatus for lighting multiple discharge lamps is provided in which two step-up transformers to apply AC voltages to two discharge lamp groups are mounted on a circuit board, and an antenna pattern is disposed on the circuit board so as to extend under both secondary windings of the step-up transformers and has its one end electrically connected to a tank circuit of a protection circuit, wherein the resonance frequency of the tank circuit is set to a frequency corresponding to five times the driving frequency of the step-up transformers, and the fifth-order high harmonic component is extracted from a signal induced in the antenna pattern, and when the signal extracted by the tank circuit exceeds a predetermined value, the output side of the step-up transformers is determined to be in an open state and the step-up transformers are stopped from being driven.

### BACKGROUND OF THE INVENTION

1. Field of the Invention

The present invention relates to a discharge lamp lighting apparatus, and particularly to a discharge lamp lighting apparatus which lights multiple discharge lamps and which is used for a backlight of a liquid crystal display device.

2. Description of the Related Art

A backlight provided with a plurality of discharge lamps, which ensures provision of sufficient screen brightness and illuminance uniformity, is used for a large liquid crystal display (LCD) device, for example, a personal computer and a television receiver.

A discharge lamp lighting apparatus (inverter device) to light multiple discharge lamps is provided with a step-up transformer to generate a high voltage and also with a protection circuit to detect a lamp current flowing through the discharge lamp to thereby prevent overcurrent from flowing through the discharge lamp (refer, for example, to Japanese Patent Application Laid-Open No. 2005-285476).

FIG. 14 is a circuit diagram of an inverter device 10 disclosed in Japanese Patent Application Laid-Open No. 2005-285476. As shown in FIG. 14, the inverter device 10 includes an output circuit 25 composed of a Royer circuit 23 and a transformer 24 for applying AC voltage to a discharge lamp (backlight) 22, a drive circuit to 26 to drive the output circuit 25, a PWM waveform oscillation circuit 28 to adjust brightness, and a protection circuit 30 to cut off AC output from the output circuit 25 at an abnormal state.

The protection circuit 30 detects a lamp current i flowing through the discharge lamp 22, and when the lamp current i has a value smaller than a predetermined value (threshold value), a control signal a for cutting off AC voltage of the output circuit 25 is output to the drive circuit 26. In this connection, if the value of the lamp current i is smaller than the threshold value, then it is either that the AC voltage output from the output circuit 25 leaks at some areas (overcurrent) or that a backlight is damaged causing an open circuit thus prohibiting current from flowing. Consequently, such abnormal states can be identified by detecting the lamp current i.

In the inverter 10 described above, the protection circuit 30 must be provided in a number equal to the number of the discharge lamps 22. In the discharge lamp lighting apparatus for use in the backlight for the LCD device, the number of discharge lamps is determined proportionally according to the screen size of the LCD device, and recently, the LCD device size is increasingly becoming larger thus increasing the quantity of discharge lamps incorporated. This requires an increased number of protection circuits pushing up component cost and production cost, which results in increasing a space for mounting components thus inevitably increasing the size of the discharge lamp lighting apparatus.

### SUMMARY OF THE INVENTION

According to an aspect of the present invention, a discharge lamp lighting apparatus for lighting multiple discharge lamps is provided, which includes: a step-up transformer group comprising at least one step-up transformer and a plurality of outputs connected to a plurality of discharge lamps; at least one bridge circuit configured to drive the step-up transformer group at a predetermined driving frequency; a control circuit configured to control an operation of the bridge circuit; an antenna pattern disposed close to a secondary winding of the step-up transformer of the step-up transformer group and in which a voltage is induced according to an output signal from the step-up transformer group; and a protection circuit configured to extract a predetermined frequency component from the voltage induced in the antenna pattern and stop the operation of the bridge circuit according to the predetermined frequency component.

### BRIEF DESCRIPTION OF THE DRAWINGS

A general configuration that implements the various features of the invention will be described with reference to the drawings. The drawings and the associated descriptions are provided to illustrate embodiments of the invention and not to limit the scope of the invention.

FIG. 1 is a circuit diagram of a discharge lamp lighting apparatus according to a first embodiment of the present invention.

FIG. 2 is a perspective view of a relevant portion of the discharge lamp lighting apparatus according to the first embodiment.

FIGS. 3A and 3B are equivalent circuit diagrams at a secondary side of a step-up transformer, referring respectively to when a discharge lamp is connected and when a discharge lamp is not connected.

FIGS. 4A and 4B are waveform graphs of vibration voltages generated at the secondary side of the step-up transformer, referring respectively to when the discharge lamp is connected and when the discharge lamp is not connected.

FIGS. 5A to 5D are waveform graphs of detection voltages when a tank circuit has an inductance of 1.03 mH.

FIGS. 6A to 6D are waveform graphs of detection voltages when the tank circuit has an inductance of 3.0 mH.

FIGS. 7A to 7D are waveform graphs of detection voltages when the tank circuit has an inductance of 5.1 mH.

FIGS. 8A to 8D are waveform graphs of detection voltages when the tank circuit has an inductance of 10.0 mH.

FIGS. 9A to 9D are waveform graphs of integrated detection voltages when the tank circuit has an inductance of 3.0 mH.

FIGS. 10A to 10D are waveform graphs of integrated detection voltages when the tank circuit has an inductance of 5.1 mH.

FIG. 11 is a perspective view of a relevant portion of a variation of the discharge lamp lighting apparatus according to the first embodiment.

FIG. 12 is a circuit diagram of a discharge lamp lighting apparatus according to a second embodiment of the present invention.

FIG. 13 is a circuit diagram of a discharge lamp lighting apparatus according to a third embodiment of the present invention.

FIG. 14 is a circuit diagram of a conventional discharge lamp lighting apparatus.

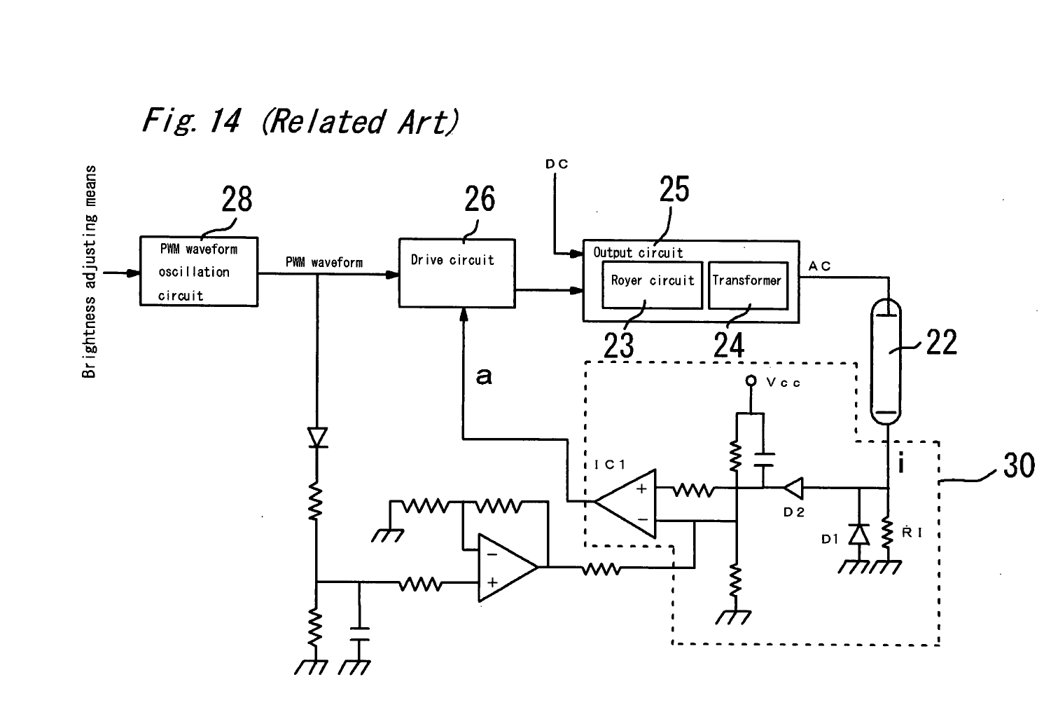

### DETAILED DESCRIPTION OF THE INVENTION

Exemplary embodiments of the present invention will hereinafter be described with reference to the accompanying drawings. The scope of the claimed invention should not be limited to the examples illustrated in the drawings and described below.

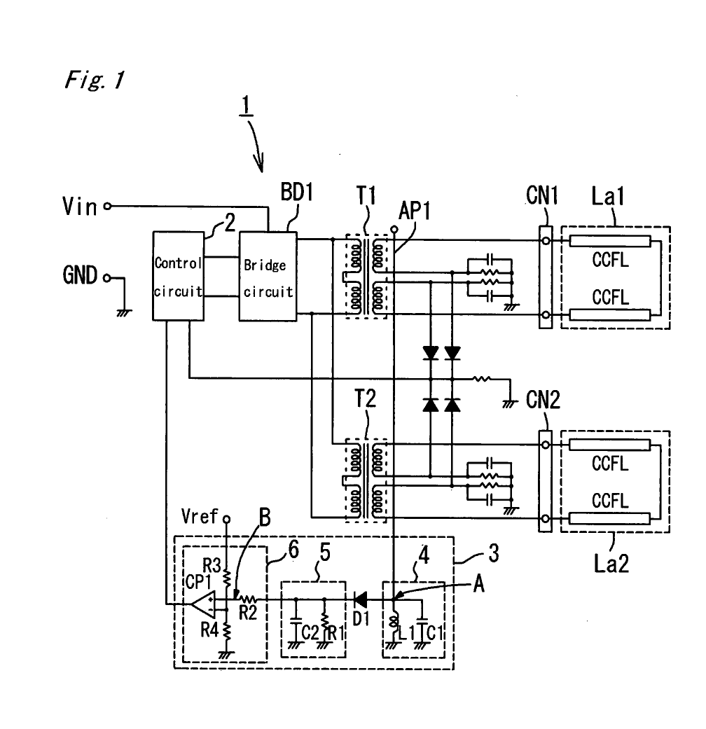

A first embodiment of the present invention will be described with reference to FIG. 1. As shown in FIG. 1, a discharge lamp lighting apparatus 1 according to the first embodiment includes a plurality (two in the present embodiment) of step-up transformers T1 and T2 as a step-up transformer group, a bridge circuit BD1 to apply an AC signal with a predetermined frequency (hereinafter referred to as “driving frequency”) to the step-up transformers T1 and T2, and a control circuit 2 to control the operation of the bridge circuit BD1.

A pair of discharge lamps (quasi-U lamp) La1 and La2 each constituted by two discharge lamps (cold-cathode fluorescent lamp (CCFL) in the present embodiment) serially connected to each other are connected to the secondary sides (output side) of the step-up transformer T1 and T2 via two-pin type lamp connectors CN1 and CN2, respectively (hereinafter the pair of discharge lamps La1 and La2 are referred to as discharge lamp groups La1 and La2, respectively). Thus, output signals (boosted voltage) from the step-up transformers T1 and T2 are applied to the discharge lamp groups La1 and La2, respectively.

With the structure described above, when the discharge lamp lighting apparatus 1 operates in the normal state, the discharge lamp groups La1 and La2 can be lit at a predetermined brightness by the output signals from the step-up transformers T1 and T2, which are based on the signal from the control circuit 2.

The discharge lamp lighting apparatus 1 further includes an antenna pattern AP1 and a protection circuit 3 for the purpose of detecting an open state (abnormal state) such as connection failure or poor connection at the discharge lamp groups La1 and La2. The antenna pattern AP1 detects the output signals from the step-up transformers T1 and T2 as a voltage signal (voltage) induced with a change in the magnetic flux leaking from the secondary winding sides. The protection circuit 3 extracts a driving frequency component (fundamental wave component) or a high-order frequency component (harmonic component) of a driving frequency from the voltage signal induced in the antenna pattern AP1, and then determines, based on the component extracted, if an open state exists or not. The following description refers to an example operation where a high-order frequency component is extracted by the protection circuit 3, but the present invention is not limited to such an operation.

Description will now be made of the structure and operation of relevant circuits.

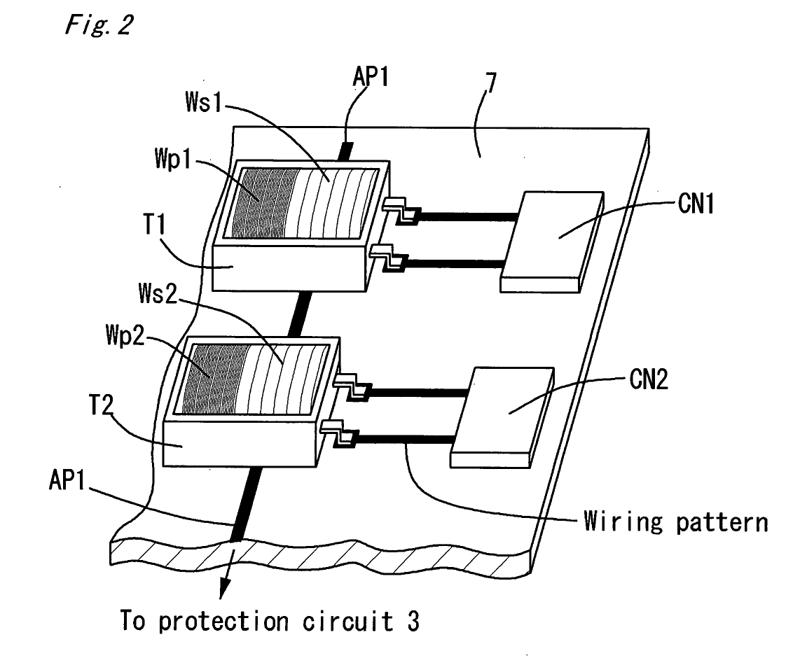

The step-up transformers T1 and T2 are, for example, a two-in-one type leakage inverter. As shown in FIG. 2, the step-up transformer T1/T2 has a primary winding Wp1/Wp2 composed of two windings connected in series to each other at the primary side and a secondary winding Ws1/Ws2 composed of two windings connected in series to each other at the secondary side, and one ends (high pressure side) of the two series-connected windings of the secondary winding Ws1/Ws2 are connected to the discharge lamp group La1/La2 via the lamp connector CN1/CN2 as well as via two/two wiring patterns formed at a circuit board 7 on which the set-up transformers T1 and T2 are mounted. With this structure, when an AC signal from the bridge circuit BD1 is applied to the primary side of the step-up transformer T1/T2, a voltage boosted according to the turn ratio between the primary side and the secondary side is induced at the secondary sides, and the boosted voltage (output signal) is applied to the discharge lamp group La1/La2.

The other ends (low pressure side) of the two series-connected windings of the secondary winding Ws1/Ws2 are each connected to ground via a parallel connection of a resistor and a capacitor. A voltage across both ends of the resistor is fed back to the control circuit 2 via a diode as a signal corresponding to current (lamp current) flowing in each discharge lamp of the discharge lamp group La1/La2.

The bridge circuit BD1 is configured as an H-bridge, for example, such that series connections of PMOSFET and NMOSFIT are connected in parallel to each other. A voltage Vin from a DC power supply and a gate signal from the control circuit 2 are applied to the bridge circuit BD1. And the bridge circuit BD1 outputs an AC signal with a frequency equivalent to a driving frequency to the primary sides of the step-up transformers T1 and T2.

The control circuit 2 includes, for example, an oscillation circuit (triangular wave circuit), a PWM circuit, an error amplification circuit, and a logic circuit (these circuits are not shown in the figure). The oscillation circuit outputs a predetermined triangular wave signal and a predetermined pulse signal to the PWM circuit and the logic circuit, respectively. Signals each formed of the lamp current of the discharge lamp group La1/La2 converted into voltage are input to the error amplification circuit, and the error amplification circuit outputs to the PWM circuit a signal for causing a predetermined current to flow in the discharge lamp group La1/La2. The PWM circuit outputs to the logic circuit a pulse signal which is modulated according to the triangular wave signal from the oscillation circuit and the output signal from the error amplification circuit. And, a gate signal for controlling the operation of the bridge circuit BD1 is generated in the logic circuit based on the pulse signal from the oscillation circuit and the modulated pulse signal from the PWM circuit and is output to the bridge circuit BD1.

The control circuit 2 further includes a halt circuit (not shown) adapted to halt the operation of the bridge circuit BD 1 according to an output signal from a protection circuit 3 to be described later herein. When it is determined according to the output signal from the protection circuit 3 that an open state occurs due to a connection failure or a poor connection at the output sides of the step-up transformers T1 and T2, the halt circuit stops, for example, the logic circuit from supplying the gate signal to the bridge circuit BD1.

The antenna pattern AP1 is a fine line wiring pattern provided on the top surface (surface on which the step-up transformers T1 and T2 are mounted) of the circuit board 7 so as to pass by the secondary windings Ws1 and Ws2 of the step-up transformers T1 and T2. In FIG. 2, the antenna pattern AP1 extends under both the secondary windings Ws1 and Ws2 of the step-up transformers T1 and T2 and has its one end opened and the other end connected to a tank circuit 4 (to be described later) of the protection circuit 3. With the structure described above, a voltage (voltage signal) is induced in the antenna pattern AP1 when magnetic fluxes are changed which leak from the secondary windings Ws1 and Ws2 of the step-up transformers T1 and T2 toward the circuit board 7, and the voltage induced is input to the protection circuit 3. The voltage induced in the antenna pattern AP1 is equivalent to a vibration voltage generated at the secondary sides of the step-up transformers T1 and T2. In this connection, the one end of the antenna pattern AP1 may be connected to ground (GND).

As shown in FIG. 1, the protection circuit 3 includes the aforementioned tank circuit 4 as resonance circuit to extract a high-order frequency component of the driving frequency of the step-up transformers T1 and T2 from the voltage signal induced in the antenna pattern AP1, an integration circuit 5 to convert an AC signal extracted by the tank circuit 4 (output signal from the tank circuit 4) into a DC signal, and a comparison circuit 5 to compare the output signal from the integration circuit 5 with a predetermined reference signal.

The tank circuit 4 is a resonance circuit which is composed of a parallel connection between a capacitor C1 and an inductor L1 and which has a resonance frequency determined by a capacity component of the capacitor C1 and an inductance component of the inductor L1. The resonance frequency of the tank circuit 4 is set to a high-order (for example, fifth order) vibration frequency of the driving frequency of the step-up transformers T1 and T2. One end of the tank circuit 4 is connected to the other end of the antenna pattern AP1, and the other end of the tank circuit 4 is connected to ground. The one end of the tank circuit 4 is connected to the input of the integration circuit 5 via a diode D1. With this arrangement, out of the voltage signal induced in the antenna pattern AP1, a component equivalent to the resonance frequency of the tank circuit 4, that is the high-order frequency component of the driving frequency is extracted by the tank circuit 4, and the extracted component is input to the integration circuit 5.

The integration circuit 5 is composed, for example, of a resistor R1 and a capacitor C2, and converts the AC signal extracted by the tank circuit 4 into a DC signal. The output of the integration circuit 5 is connected to the input of the comparison circuit 6, wherein an output signal (DC signal) from the integration circuit 5 is input to the comparison circuit 6.

The comparison circuit 6 is composed, for example, of a comparator CP1 and resistors R1, R3, and R4. The output of the integration circuit 5 is connected to the non-inverting input terminal (+terminal) of the comparator CP1 via the resistor R2. A reference voltage Vref divided by the resistors R2 and R3 is input to the inverting terminal (−terminal) of the comparator CP1. With this arrangement, the output signal (DC signal) from the integration circuit 5 is compared with the reference voltage Vref, and a difference therebetween is output from the comparison circuit 6. The output of the comparison circuit 6 is connected to the halt circuit of the control circuit 2, and the output signal (difference output) from the comparison circuit 6 is fed to the control circuit 2. The control circuit 2, as described above, halts the operation of the bridge circuit BD1 according to the output signal from the comparison circuit 6 (the protection circuit 3) (for example, when the output signal from the integration circuit 5 exceeds the reference voltage Vref). In this connection, the comparison circuit 6 may be arranged to feed the control circuit 2 with an alternative signal (halt signal based on the difference output) to halt the operation of the bridge BD circuit 1 in place of the difference output.

Detailed description will now be made of protection operation performed by the antenna pattern AP1 and the protection circuit 6.

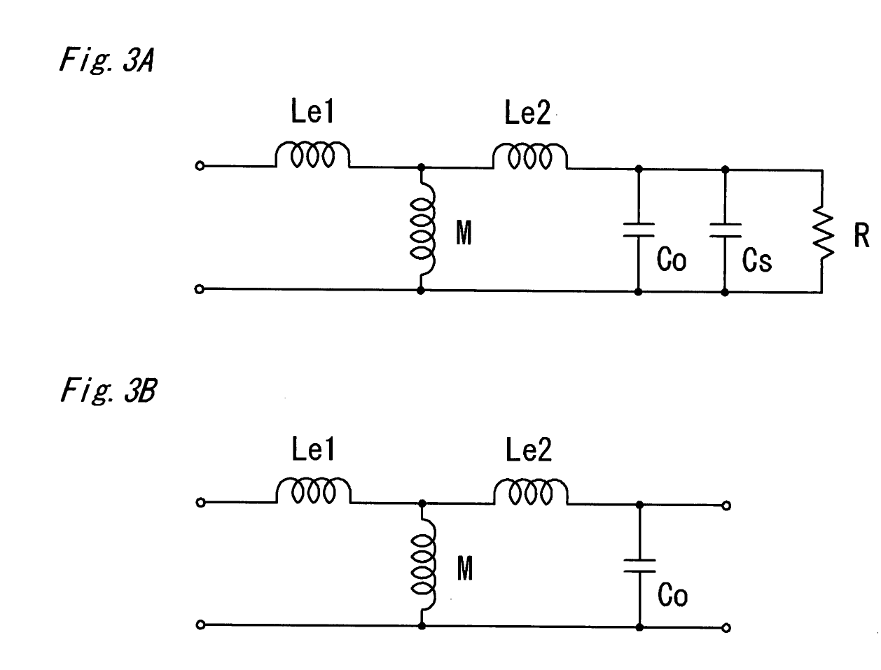

FIGS. 3A and 3B show respective equivalent circuits at the secondary side of the step-up transformer T1 including the discharge lamp group La1, wherein FIG. 3A shows a case where the discharge lamp group La1 is connected to the lamp connector CN1 while FIG. 3B shows a case where the discharge lamp group La1 is not connected to the lamp connector CN1.

As shown in FIG. 3A, when the discharge lamp group La1 is connected to the lamp connector CN1, a resonance circuit is constituted by a mutual inductance M, a leakage inductance Le2 at the secondary side of the step-up transformer T1, and a composite capacitance of an additional capacitance Co at the secondary side of the step-up transformer T1 combined with a parasitic capacitance Cs at the lamp. On the other hand, when the discharge lamp group La1 is not connected to the lamp connector CN1, a resonance circuit is constituted by the mutual inductance M, the leakage inductance Le2, and the additional capacitance Co at the secondary side of the step-up transformer T1 as shown in FIG. 3B. Both equivalent circuits are resonance circuits including a parallel resonance circuit and a series resonance circuit in combination. In this connection, a leakage inductance Le1 at the secondary side of the step-up transformer T1 is a circuit constant which does not practically take part in resonance.

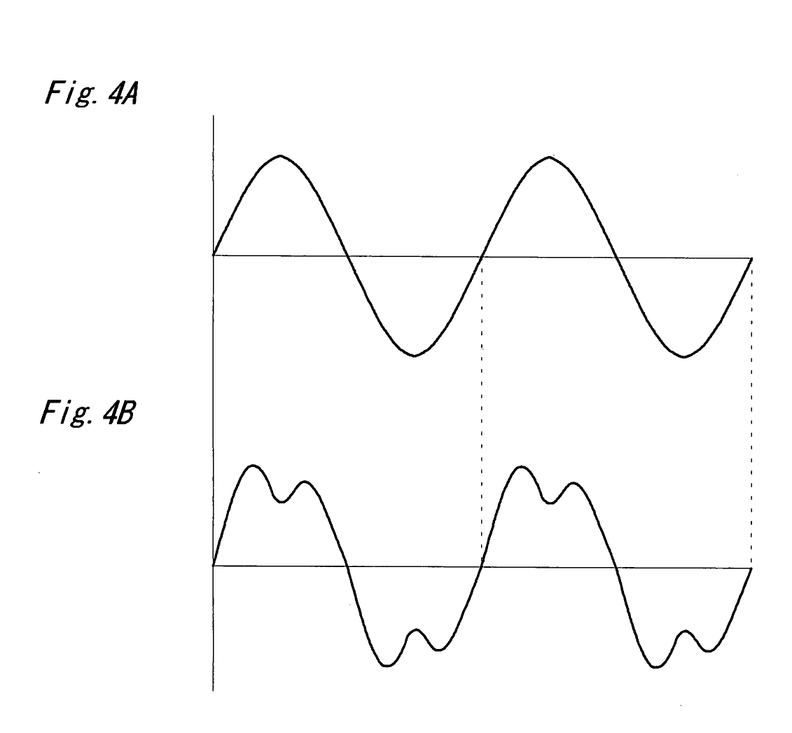

FIGS. 4A and 4B schematically show waveforms of vibration voltages generated at the secondary side of the step-up transformer T1 (horizontal axis: time, vertical axis: voltage), wherein FIG. 4A shows a case where the discharge lamp group La1 is connected to the lamp connector CN1 while FIG. 4B shows a case where the discharge lamp group La1 is not connected to the lamp connector CN1.

At the time of normal operation when the discharge lamp group La1 is connected to the lamp connector CCN1, the driving frequency and the circuit constant are adjusted so as to form a waveform shown in FIG. 4A where an unwanted high-frequency wave component is not superimposed on a sine waveform corresponding to the driving frequency of the step-up transformer T1, that is a fundamental wave. Specifically, a driving frequency is set substantially halfway between the primary side parallel resonance frequency and the primary side series resonance frequency, thereby suppressing generation of a high-frequency wave component. In such an arrangement, when the discharge lamp group La1 is not connected to the lamp connector CN1, the respective resonance frequencies of the parallel and series resonance circuits are caused to vary thus presenting a distorted waveform as shown in FIG. 4B, that is a waveform produced such that a high-order frequency wave component is superimposed on a fundamental wave. This means that when the discharge lamp group La1 is not normally connected to the lamp connector CN1 thus causing an open state, the high-order frequency wave component of the driving frequency is superimposed on the vibration voltage generated at the secondary side of the step-up transformer T1.

The vibration voltage generated at the secondary side of the step-up transformer T1 is detected as a voltage induced in the antenna pattern AP1, and the induced voltage is input to the tank circuit 4 of the protection circuit 3. The resonance frequency of the tank circuit 4 is set to one of the high-order frequencies of the driving frequency (one multiple number of the driving frequency). Consequently, when an open state occurs, the vibration voltage of a frequency corresponding substantially to the resonance frequency of the tank circuit 4 among the high-order frequencies of the driving frequency is extracted by the tank circuit 4 from the voltage signal induced in the antenna pattern AP1, whereby a higher voltage signal than at the normal operation is generated across the both terminals of the tank circuit 4.

The voltage signal generated at the tank circuit 4 is converted into a DC signal at the integration circuit 5 and then input to the non-inverting terminal (+) of the comparator CP1. The comparator CP1 compares the voltage signal input to the non-inverting terminal (+) with the reference voltage Vref input to the inverting terminal (−). The reference voltage Vref is set to a predetermined value which enables determination of an open state caused by connection failure or poor connection. Specifically, if the difference signal from the comparator CP1 exceeds a predetermined value (for example, 1.0 V), it can be determined that an open state occurs.

In the present embodiment, the antenna pattern AP1 composed of one common conductive pattern is arranged for provision of the two step-up transformers T1 and T2. With this arrangement, if an open state occurs between one end of at least one of the two discharge lamp groups La1 and La2 and a pin of the two lamp connectors CN1 and CN2, then a high-order frequency component is induced in the antenna pattern AP1. Thus, for provision of the plurality of discharge lamp groups La1 and La2, an open state can be duly detected by the one common antenna pattern AP1 and the protection circuit 30. Similarly, an open state can be detected for provision of three or more step-up transformers. Accordingly, the number of components can be reduced thus providing advantages of reducing cost and size.

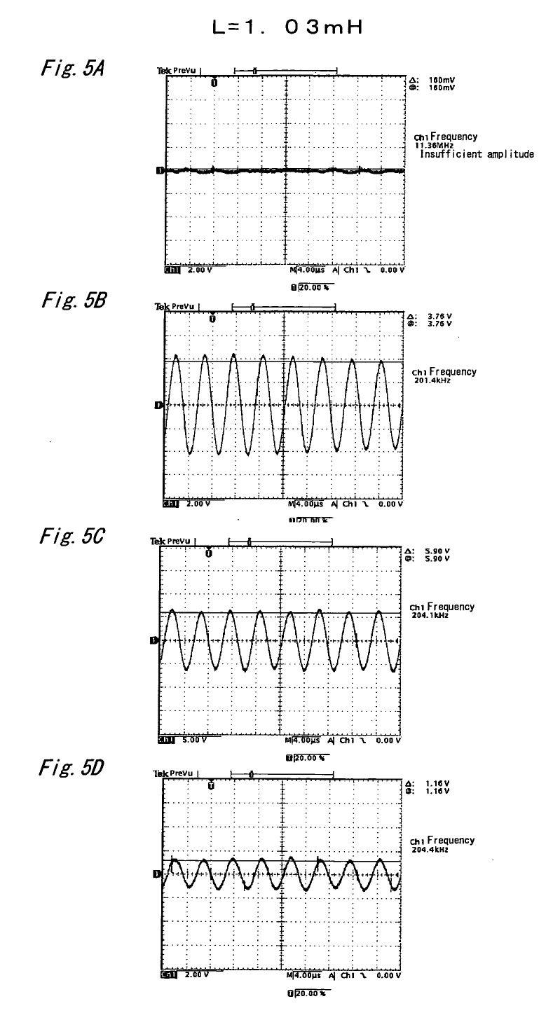

In order to more concretely explain the structure and protection operation of the protection circuit 3, description will be made, with reference to FIGS. 5A to 5D, 6A to 6D, 7A to 7D and 8A to 8D, about an example of the discharge lamp lighting apparatus 1 in which five step-up transformers T1 to T5 are connected in parallel to the bridge BD1, where five discharge lamp groups La1 to La5 and five lamp connectors CN1 to CN5 are provided.

The driving frequency of the step-up transformers T1 to T5 at the normal operation is set at 41.0 kHz, and the resonance frequency of the tank circuit 4 is set at 200 kHz which corresponds to five times the driving frequency of 41.0 kHz (fifth-order high frequency). Also, in order to increase the impedance of the tank circuit 4 at a resonance frequency of 200 kHz, the inductance vale of the inductor L1 is set between 1.0 mH and 10.0 mH.

FIGS. 5A to 5D, 6A to 6D, 7A to 7D and 8A to 8D show output voltage waveforms (voltage waveform at a portion A shown in FIG. 1) of the tank circuit 4 where the inductor L1 has a value of 1.03 mH, 3.0 mH, 5.1 mH and 10.0 mH, respectively. FIGS. 5A, 6A, 7A and 8A show respective voltage waveforms when all of the discharge lamp groups La1 to La5 are normally connected to the lamp connectors CN1 to CN5 (normal operation state), FIGS. 5B, 6B, 7B and 8B show respective voltage waveforms when none of the discharge lamp groups La1 to La5 are connected to the lamp connectors CN1 to CN5 (entirely open state), FIGS. 5C, 6C, 7C and 8C show respective voltage waveforms when one of the discharge lamp groups La1 to La5 is not connected to its corresponding one of the lamp connectors CN1 to CN5, and FIGS. 5D, 6D, 7D and 8D show respective voltage waveforms when one end of one of the discharge lamp groups La1 to La5 is not connected to a pin of its corresponding one of the lamp connectors CN1 to CN5.

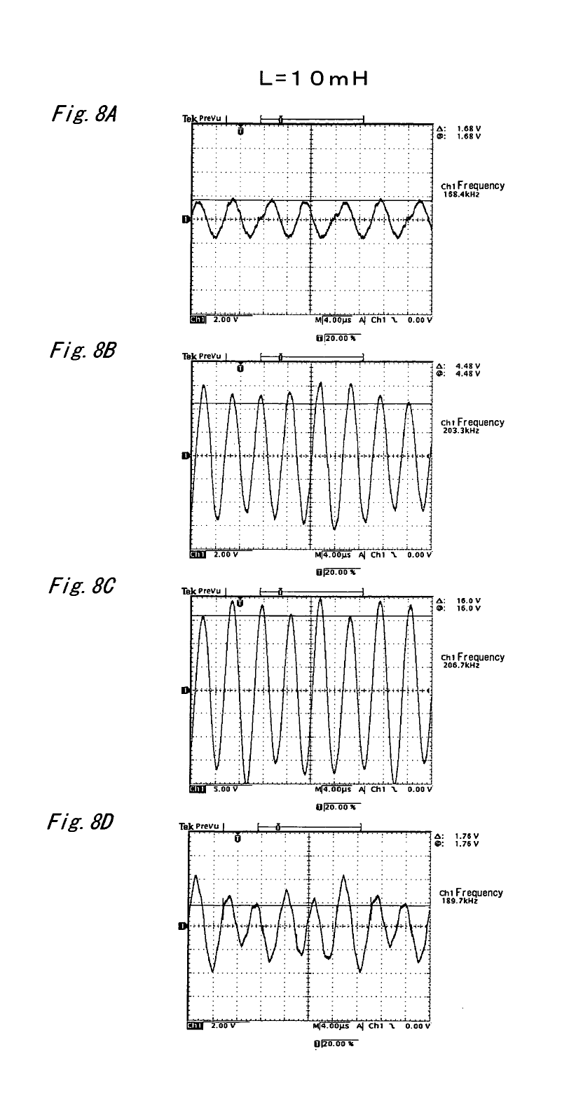

Referring to FIGS. 5A, 6A, 7A and 8A, at the normal operation, since the high-order frequency component is suppressed from being generated, the output voltage at the portion A of the tank circuit 4 measures substantially at zero V except in the case the inductor L1 has a value of 10.0 mH as shown in FIG. 8A where an average voltage at the portion A is 1.68 Vo-p (zero-to-peak) which is a relatively large value. This is considered to be due to the fact that the inductance value is too large and so a large amount of noise is picked up.

At the entirely open state where none of the discharge lamp groups La1 to La5 are connected to the lamp connectors CN1 to CN5, an average voltage at the portion A is about 4.0 Vo-p (zero-to-peak) for all cases regardless of the value of the inductor L1 as shown in FIGS. 5B, 6B, 7B and 8B.

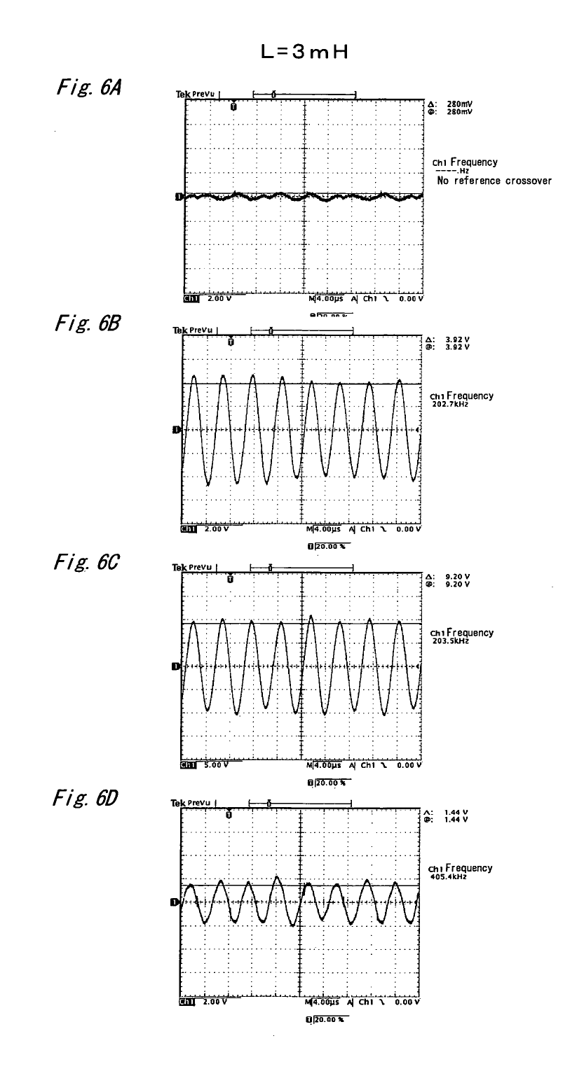

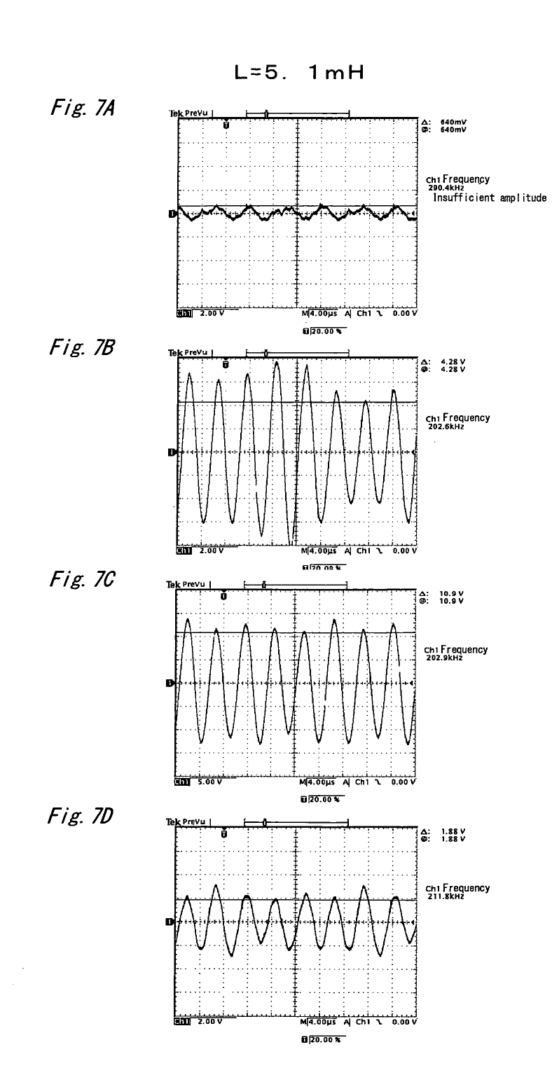

When the discharge lamp group La1 (one of the discharge lamp groups La1 to La5) is not connected to its corresponding one of the lamp connectors CN1 to CN5 as shown in FIGS. 5C, 6C, 7C and 8C, an average voltage at the portion A is about 10.0 Vo-p (zero-to-peak) in the cases of the inductor L1 having a value of 3.0 mH (FIG. 6C) and 1.0 mH (FIG. 7C), while an average voltage at the portion A in the case of the inductor L1 having a value of 1.03 mH (FIG. 5C) is 5.90 Vo-p (zero-to-peak) which is a relatively small value, and an average voltage at the portion A in the case of the inductor L1 having a value of 10.0 mH (FIG. 8C) is 16.0 Vo-p (zero-to-peak) which is a relatively large value. The relatively small value shown in FIG. 5C is attributed to the inductor L1 having a too small value resulting in a low detection sensitivity, while the relatively large value shown in FIG. 8C is attributed to the inductor L1 having a too large value resulting in picking up a large amount of noise.

Referring to FIGS. 5D, 6D, 7D and 8D, when one end of the discharge lamp group La1 (one of the discharge lamp groups La1 to La5) is not connected to a pin of the lamp connectors CN1 to CN5, an average voltage at the portion A is 1.4 Vo-p (zero-to-peak) or more except in the case the inductor L1 has a value of 1.03 mH as shown in FIG. 5D. When the inductor L1 has a value of 1.03 mH, an average voltage at the portion A is 1.16 Vo-p (zero-to-peak) which is a relatively small value, and this is considered to be due to the fact that the inductance value is too small resulting in low detection sensitivity.

The above results show that an open state can be precisely detected if the inductor L1 is set to have a value of about 3.0 mH to 5.0 mH.

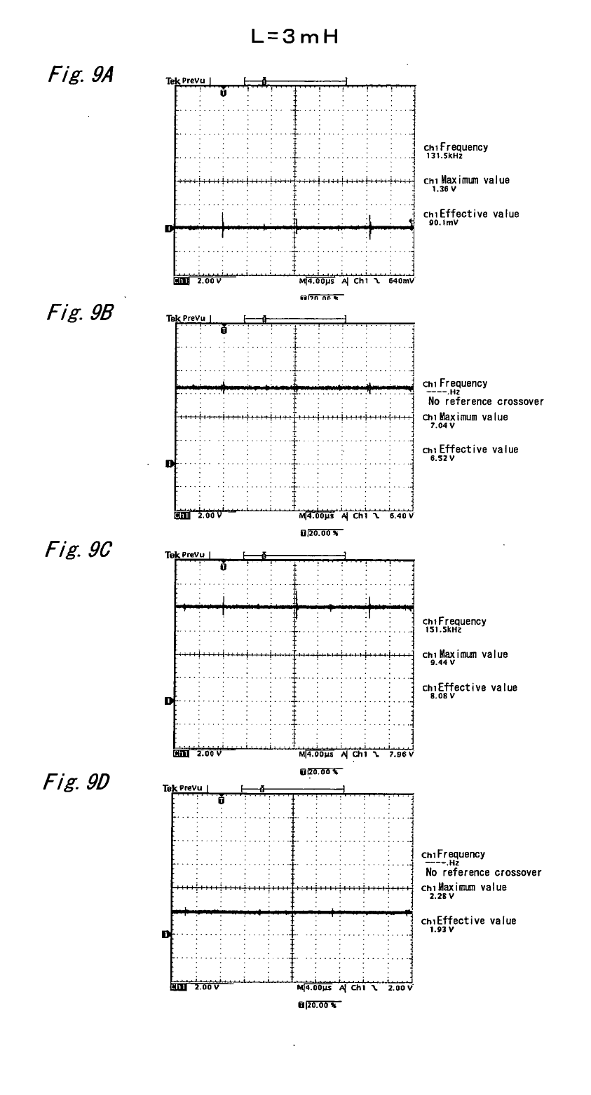

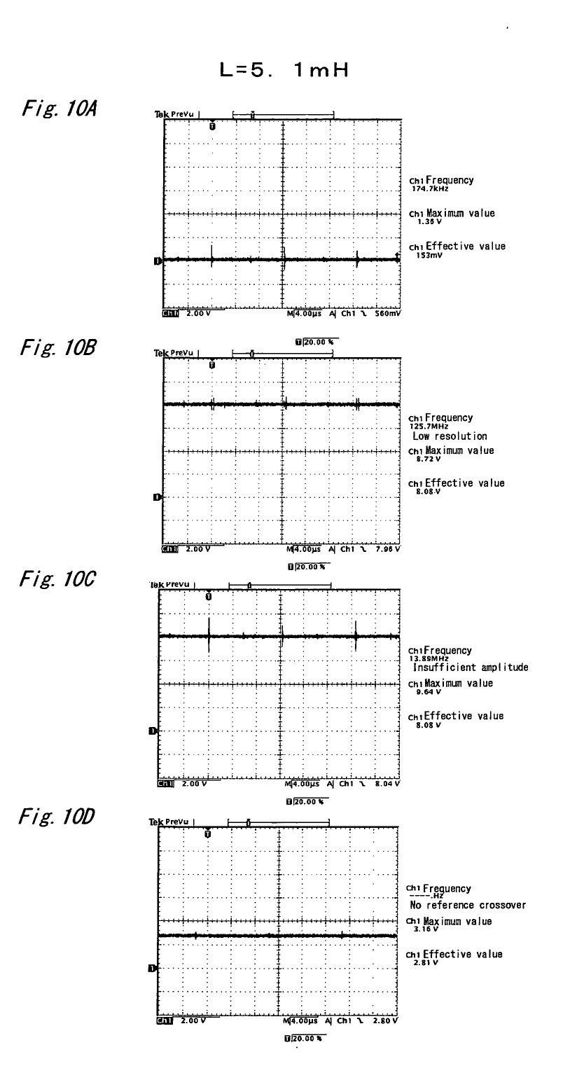

Description will now be made, with reference to FIGS. 9A to 9D and 10A to 10D, of a voltage waveform (voltage waveform at a portion B of the comparison circuit 6 shown in FIG. 1) at the non-inverting input (+) of the comparator CP1. FIGS. 9A to 9D and 10A to 10D show voltage waveforms at the portion B, referring respectively to when the inductor L1 has a value of 3.0 mH and when the inductor L1 has a value of 5.1 mH. FIGS. 9A and 10A show respective voltage waveforms when all of the discharge lamp groups La1 to La5 are normally connected to the lamp connectors CN1 to CN5, respectively (normal operation state), FIGS. 9B and 10B show respective voltage waveforms when none of the discharge lamp groups La1 to La5 are connected to the lamp connectors CN1 to CN5 (entirely open state), FIGS. 9C and 10C show respective voltage waveforms when the discharge lamp group La1 (one of the discharge lamp groups La1 to La5) is not connected to its corresponding one of the lamp connectors CN1 to CN5, and FIGS. 8D and 10D show respective voltage waveforms when one end of the discharge lamp group La1 (one of the discharge lamp groups La1 to La5) is not connected to a pin of its corresponding one of the lamp connectors CN1 to CN5.

An effective voltage (DC voltage) at the portion B under the different connection conditions of the discharge lamp groups La1 to La5 is 90.1 mV (FIG. 9A), 6.52 V (FIG. 9B), 8.08 V (FIG. 9C) and 1.93 V (FIG. 9D) when the inductor L1 has a value of 3.0 mH, and is 153.0 mV (FIG. 10A), 8.08 V (FIG. 10B), 8.08 V (FIG. 10C) and 2.81 V (FIG. 10D) when the inductor L1 has a value of 5.01 mH.

The above results show that if the reference voltage Vref of the inverting input terminal (−) of the comparator CP1 is set at, for example, 1.0 V, an open state can be accurately detected at any case, specifically, when none of the discharge lamp groups La1 to La5 are connected to the lamp connectors CN1 to CN5, when one of the discharge lamp groups La1 to La5 is not connected to its corresponding one of the lamp connectors CN1 to CN5, and when one end of one of the discharge lamp groups La1 to La5 is not connected to a pin of its corresponding one of the lamp connectors CN1 to CN5.

Thus, in the discharge lamp lighting apparatus 1, the vibration voltage induced at the secondary side of the step-up transformers T1 to Tn (n=arbitrary positive integer) is detected as an induced voltage by the antenna pattern AP1 disposed close to the secondary windings Ws1 to Wsn of the step-up transformers T1 to Tn, and the induced voltage is input to the tank circuit 4 of the protection circuit 3. The resonance frequency of the tank circuit 4 is set to any one frequency (any one of high-order frequencies of the driving frequency) of the harmonic wave generated when the discharge lamp groups La1 to Lan are not normally connected to the lamp connectors CN1 to CNn, whereby when the output side of the step-up transformer T1 to Tn also is open thus presenting an abnormal state, the vibration voltage of the high-order frequency equal substantially to the resonance frequency of the tank circuit 4 is extracted by the tank circuit 4 among the induced voltages detected by the antenna pattern AP1, and a voltage signal having a larger value than at the normal state is generated across the both ends of the tank circuit 4. Consequently, the open state at the output side of the step-up transformers T1 to Tn can be detected by the signal extracted by the tank circuit 4.

The antenna pattern AP is one conductive pattern common to the plurality of step-up transformers T1 to Tn on the circuit board 7, and the protection circuit 3 including the tank circuit 4 is provided as one circuit common to all of the discharge lamp groups La1 to Lan, whereby in the discharge lamp lighting apparatus 1, the number of circuit components for detecting an abnormal lamp current can be reduced significantly compared with a conventional discharge lamp lighting apparatus. Accordingly, a detection circuit can be provided less expensively while a good detection precision is maintained. Also, since the circuitry is simplified, the area on which components are mounted can be reduced thus enabling downsizing of the apparatus.

In the present embodiment, the resonance frequency of the tank circuit 4 is set to five times the driving frequency of the step-up transformers T1 to Tn of the normal operation. The present invention is not limited to this setting arrangement, and the resonance frequency of the tank circuit 4 may be optimally set to any odd number times the driving frequency (the driving frequency or an odd numbered high-order frequency thereof) depending on the circuitries. In this connection, the frequency defined as odd number times the driving frequency includes the neighborhood of each frequency to such an extent that a signal enabled to distinguish between the normal state and the abnormal state can be extracted by the frequency.

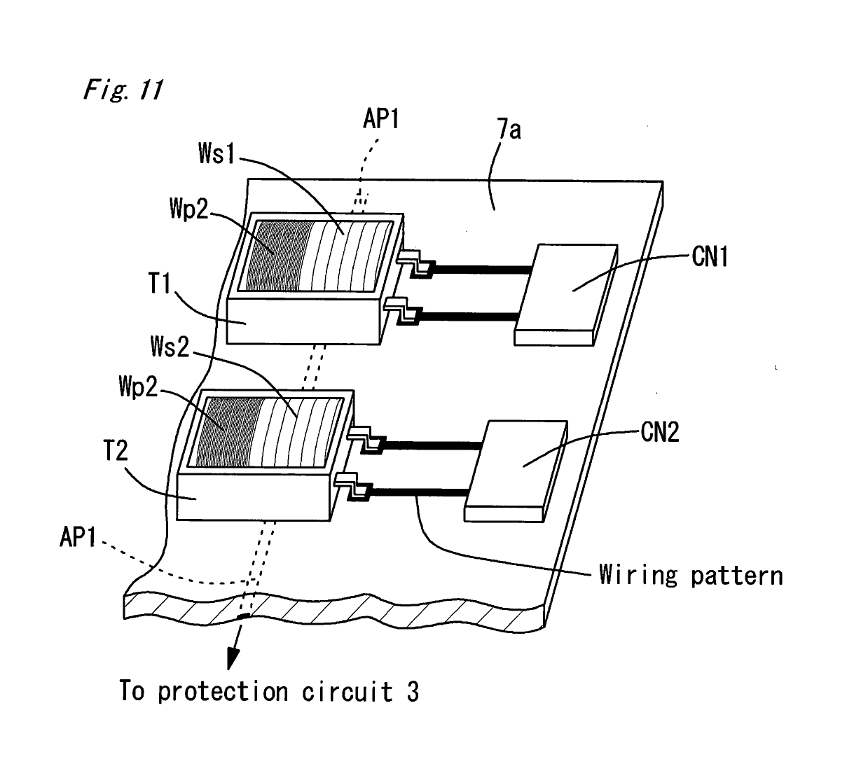

Also, the antenna pattern AP1, which is located near the secondary windings Ws1 to Wsn of the step-up transformers T1 to Tn and which, in the present embodiment, is disposed on a surface (mounting surface) of the circuit board 7 on which the step-up transformers T1 to Tn are mounted, may alternatively be disposed, for example, on a surface (opposite surface) of the circuit board 7 opposite to the mounting surface provided with the step-up transformers T1 to Tn as shown in FIG. 11. Further alternatively, though not shown, the antenna pattern AP1, which is located near the secondary windings Ws1 to Wsn, may be embedded in the circuit board 7. When the antenna pattern AP1 is disposed at the opposite surface of the circuit board 7 or embedded in the circuit board 7, the creepage distance from the antenna pattern AP1 to high pressure patterns (four wiring patterns shown in FIGS. 2 and 11) mounted on the mounting surface can be increased. Also, in this arrangement, since other wiring patterns are not disposed on the same plane as the antenna pattern AP1, the antenna patter AP1 can be more freely positioned.

While the discharge lamp groups La1 to Lan are each constituted by a quasi U-shaped lamp composed of two discharge lamps connected in series to each other in the present embodiment, a U-shaped lamp may be used in place of each of the discharge lamp groups La1 to Lan.

In the present embodiment, the plurality of discharge lamp groups La1 to Lan are floating-connected to each other but may be connected respectively to ground.

One step-up transformer T1 whose secondary side is connected to a plurality of discharge lamps may constitute the step-up transformer group according to the present invention.

In the present embodiment, the low pressure sides of the secondary windings Wa1 to Wsn of the step-up transformers T1 to Tn are each connected to ground via a parallel connection composed of a resistor and a capacitor, wherein a voltage across both ends of the resistor is fed back to the error amplification circuit of the control circuit 2 via a diode as a voltage signal converted from current flowing in the discharge lamp. Alternatively, the low pressure sides of the secondary windings Ws1 to Wsn of the step-up transformers Ta to T1n may be connected to each other.

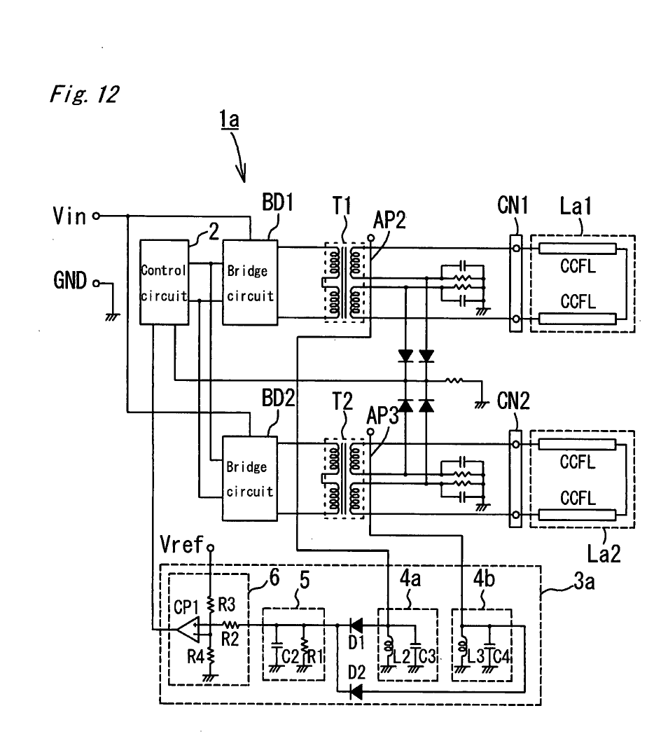

A second embodiment of the present invention will be described with reference FIG. 12. FIG. 12 shows a discharge lamp lighting apparatus 1a according to the second embodiment. In explaining the example of FIG. 12, any components corresponding to those of the discharge lamp lighting apparatus 1 described above are denoted by the same reference numerals, and a detailed description thereof will thus be omitted in the following description.

The discharge lamp lighting apparatus 1a includes a plurality (two in the present embodiment) of two-in-one type step-up transformers T1 and T2 as step-up transformer group, a plurality (two in the present embodiment) of bridge circuits BD1 and BD2 to apply respective AC signals to the step-up transformers T1 and T2, and a control circuit 2 to control the driving operation of the bridge circuits BD1 and BD2. The step-up transformers T1 and T2 are connected to a plurality (two in the present embodiment) of discharge lamp groups La1 and La2 via a plurality (two in the present embodiment) of two-pin type lamp connectors CN1 and CN2. The discharge lamp groups La1 and La2 are each composed of two discharge lamps (CCFL) connected in series to each other.

The discharge lamp lighting apparatus 1a further includes a plurality (two in the present embodiment) of antenna patterns AP2 and AP3 and a protection circuit 3a. The protection circuit 3a includes a plurality (two in the present embodiment) of tank circuits 4a and 4b, an integration circuit 5 and a comparison circuit 6.

One antenna pattern AP2 is located close to a secondary winding Ws1 of the step-up transformer T1. The antenna pattern AP2 extends under the step-up transformer T1 wherein one end thereof is opened like the antenna pattern AP1 shown in FIG. 2, and the other end is connected to one tank circuit 4a. In this connection, the one end of the antenna pattern AP2 may be connected to ground (GND).

The other antenna pattern AP3 is located close to a secondary winding Ws2 of the step-up transformer T2. The antenna pattern AP3 extends under the step-up transformer T2 wherein one end thereof is opened like the antenna pattern AP1 shown in FIG. 2, and the other end is connected to the other tank circuit 4b. In this connection, the one end of the antenna pattern AP3 may be connected to ground (GND).

One ends of the tank circuits 4a and 4b are connected respectively to the antenna pattern AP2 and AP3 and are connected to the input of the common integration circuit 5 via diodes D1 and D2, respectively. The output of the integration circuit 5 is connected to the input of the common comparison circuit 6.

In the discharge lamp lighting apparatus 1a described above, an abnormal state can be duly detected when an open state exists between one end of at least one of the two discharge lamp groups La1 and La2 connected to the secondary sides of the step-up transformers T1 and T2 and a pin of the lamp connectors CN1 and CN2. That is to say, the discharge lamp lighting apparatus 1a achieves the same advantageous effect as the discharge lamp lighting apparatus 1.

In the discharge lamp lighting apparatus 1a, the antenna patterns AP2 and AP2 are respectively disposed close to the secondary windings Ws1 and Ws2 of the step-up transformers T1 and T2 while being connected respectively to the tank circuits 4a and 4b independent of each other, whereby the resonance frequencies of the tank circuits 4a and 4b can be set independently to respective high-order frequencies which may be generated differently between the discharge lamp group La1 and the discharge lamp group La2 at the time of an abnormal operation. As a result, the open state can be precisely detected for each of the discharge lamp groups La1 and La2. Also, one integration circuit and one comparison circuit in the protection circuit can be used commonly for the plurality of step-up transformers thus achieving cost reduction and downsizing of the protection circuit.

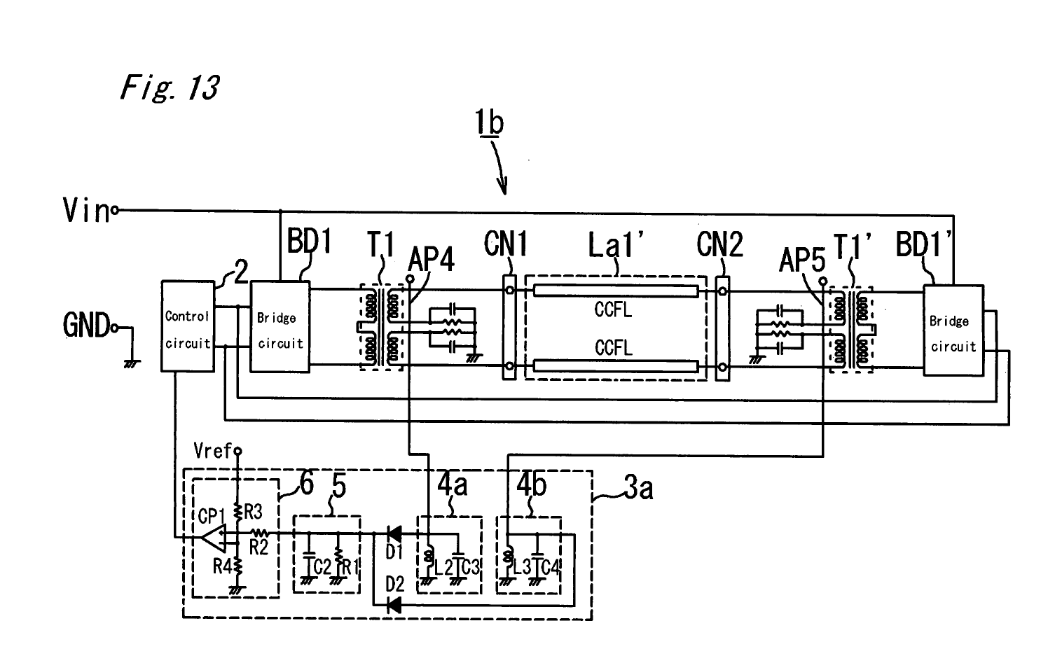

A third embodiment of the present invention will be described with reference to FIG. 13. FIG. 13 shows a circuit diagram of a discharge lamp lighting apparatus 1b according to the third embodiment. In explaining the example of FIG. 13, any components corresponding to those of the discharge lamp lighting apparatus 1 described above are denoted by the same reference numerals, and a detailed description thereof will be omitted below.

The discharge lamp lighting apparatus 1b includes two two-in-one type step-up transformers T1 and T1′ as step-up transformer group, two bridge circuits BD1 and BD1′ to apply respective AC signals to the step-up transformers T1 and T1′, and a control circuit 2 to control the driving operation of the bridge circuit BD1 and BD1′. The step-up transformers T1 and T1′ are connected respectively to both ends of one discharge lamp group La1′ via two-pin type lamp connectors CN1 and CN2.

The discharge lamp group La1′ is composed of two discharge lamps (CCFL) arranged parallel to each other. Both ends of one discharge lamp of the discharge lamp group La1′ are connected to respective one high pressure sides of secondary windings of the step-up transformers T1 and T1′ via one pins of the lamp connectors CN1 and CN2, and both ends of the other discharge lamp of the discharge lamp group La1′ are connected to respective other high pressures sides of the secondary windings of the step-up transformers T1 and T1′ via the others pins of the lamp connectors CN1 and CN2.

The discharge lamp lighting apparatus 1b further includes two antenna patterns (branch antenna patterns) AP4 and AP5 and a protection circuit 3a. The protection circuit 3a includes two tank circuits 4a and 4b, an integration circuit 5 and a comparison circuit 6.

The antenna patterns AP4 and AP5 and the protection circuit 3a are structured as with the antenna patterns AP2 and AP3 and the protection circuit 3, respectively, of the discharge lamp lighting apparatus 1a. The antenna patterns AP4 and AP5 are located close to the respective secondary windings of the step-up transformers T1 and T1′.

Specifically, the antenna pattern AP4 extends under the step-up transformer T1 and close to the secondary winding thereof wherein one end thereof is opened and the other end is connected to one tank circuit 4a of the protection circuit 3a, and the antenna pattern AP5 extends under the step-up transformer T1′ and close to the secondary winding thereof wherein one end thereof is opened and the other end is connected to other tank circuit 4b of the protection circuit 3a. In this connection, the one ends of the antenna patterns AP4 and AP5 may be connected to ground (GND).

In the discharge lamp lighting apparatus 1b described above, an abnormal state can be duly detected when an open state exists between one end of at least one discharge lamp of the discharge lamp group La1′ connected to the secondary sides of the step-up transformers T1 and T1′ and a pin of the lamp connectors CN1 and CN2. That is to say, the discharge lamp lighting apparatus 1b achieves the same advantageous effect as the discharge lamp lighting apparatus 1.

While the present invention has been illustrated and explained with respect to specific embodiments thereof, it is to be understood that the present invention is by no means limited thereto but encompasses all changes and modifications that will become possible within the scope of the present invention.

For example, the step-up transformer T1 and T2 do not have to be a two-in-one type transformer but may be constituted by a plurality of single transformers, or a four-in-one type transformer. Also, the two-in-one type transformer may be a differential transformer or an in-phase transformer.

The antenna patterns AP1 to AP5 do not have to extend under the step-up transformers but may extend at any side of the step-up transformers as long as they are disposed close to the secondary windings thereof.

The bridge circuits BD1 and BD2 do not have to be a full-bridge circuit but may be a half-bridge circuit composed of two switching elements connected in series to each other, or a push-pull circuit.

The logic of the comparator CP1 of the protection circuits 3/3a may be positive or negative logic, and the comparator may be an OP amplifier.

What is claimed is:

1. A discharge lamp lighting apparatus for lighting multiple discharge lamps, the apparatus comprising:
a step-up transformer group comprising at least one step-up transformer and a plurality of outputs connected to a plurality of discharge lamps;
at least one bridge circuit for driving the step-up transformer group at a predetermined driving frequency;
a control circuit for controlling an operation of the bridge circuit;
an antenna pattern which is disposed close to a secondary winding of the step-up transformer of the step-up transformer group and in which a voltage is induced according to an output signal from the step-up transformer group; and
a protection circuit which extracts a predetermined frequency component from the voltage induced in the antenna pattern and which stops the operation of the bridge circuit according to the predetermined frequency component.

2. A discharge lamp lighting apparatus according to claim 1, wherein a frequency of the predetermined frequency component is one of the driving frequency and an odd numbered high-order frequency of the driving frequency.

3. A discharge lamp lighting apparatus according to claim 1, wherein the protection circuit comprises:
a resonance circuit for extracting the predetermined frequency component from the voltage induced in the antenna pattern;
an integration circuit for converting an output signal from the resonance circuit into a DC signal; and
a comparison circuit for comparing an output signal from the integration circuit with a predetermined reference signal.

4. A discharge lamp lighting apparatus according to claim 3, wherein the resonance circuit is a tank circuit comprising an inductor and a capacitor which are connected in parallel to each other.

5. A discharge lamp lighting apparatus according to claim 1, wherein the step-up transformer group comprises a plurality of step-up transformers, and wherein the antenna pattern comprises one conductive pattern common to the plurality of step-up transformers.

6. A discharge lamp lighting apparatus according to claim 2, wherein the step-up transformer group comprises a plurality of step-up transformers, wherein the antenna pattern comprises a plurality of conductive patterns provided respectively for the plurality of step-up transformers of the step-up transformer group, wherein the protection circuit comprises a plurality of resonance circuits, and wherein the voltage induced at each of the plurality of conductive patterns of the antenna pattern is input individually to each of the resonance circuits of the protection circuit.

7. A discharge lamp lighting apparatus according to claim 1, wherein the antenna pattern is either disposed on a surface of a circuit board opposite to a mounting surface thereof on which the step-up transformer group is mounted, or embedded in the circuit board.
